(19) United States
(12) Patent Application Publication
(10) Pub. No.: US 2011/0198341 A1
(43) Pub. Date: Aug. 18, 2011

(54) Constant watt-density heating film

(76) Inventor: Donald Allen Gilmore, Kansas City, MO (US)

(21) Appl. No.: 12/658,900

(22) Filed: Feb. 17, 2010

(51) Int. Cl. H05B 3/02

(52) U.S. Cl. 219/539

(57) ABSTRACT

A very thin, laminated sheet material supplies evenly-distributed heat over its entire surface when an electrical voltage is applied to its opposite faces has an interior layer material sandwiched between outer layer materials. The sheet may be cut into any shape and produces an even heat with a constant watt-density over its entire surface at the same low voltage, regardless of size. The voltage may be applied at any point on the opposite faces of the material to produce the same effect.

### FIELD OF THE INVENTION

This invention relates to a thin, lightweight, electrically-heated film that can be cut into any shape and produce a constant watt-density, regardless of size when a low voltage is applied anywhere on its opposite faces.

### BACKGROUND OF THE INVENTION

Presently, most heated surface devices utilize a heated linear element, like an electrically-heated wire element, or a pipe element flowing with heated fluid, that is distributed over the surface to be heated by winding it in a serpentine pattern and terminating the ends permanently in one location. The element must then be held in place by a surrounding matrix material or a bracket apparatus. A surface heated by such a device has hot areas, where the element is, and cooler areas in the spaces between segments of the element, which results in uneven heating and requires that the device be pre-engineered to fit a given space and to produce the desired heat flow characteristics. For example, if it is desired that a one-meter-diameter circular area be heated at 50 watts per square meter, a specific serpentine pattern must be designed for the element to fill the circular area and an element must be selected with specific thermal properties, depending on its length and the spacings within the pattern. A permanent location for the terminal ends of the element must then also be decided upon. Thus, such heaters are necessarily custom-engineered and manufactured for each particular application, rendering them time-consuming, bulky, heavy and expensive to produce and only useful for a specific application.

In the case of the electrical version of such an existing device, as a desired area to be heated becomes larger, a longer element is required, increasing the total resistance of the element and requiring correspondingly higher voltages to produce the same heating characteristics. The voltage required to power larger and larger areas eventually reaches hazardous levels, particularly if the heater is within human contact.

In the case of the piped fluid version of such an existing system, as the heated fluid travels through the pipe, it loses heat energy all along its path becoming cooler and cooler in temperature. This results in uneven heating and eventually the fluid can cool so much as to become ineffectual, requiring intermediate re-heating.

The present invention is directed to overcoming one or more of the problems set forth above.

### SUMMARY OF INVENTION

The present invention comprises a plurality of layers of electrically-conductive material, the common faces of which are in electrical contact with one another. An interior layer is made of a material that possesses a high electrical resistivity. On each of the outer faces of this interior layer is applied or affixed an outer layer of material that possesses a low electrical resistivity. The layers are permanently attached across their mating surfaces so that they are in continuous electrical contact over the entire interface. This results in a thin, laminated film comprising the low-resistivity layers with a high-resistivity layer sandwiched between them.

When an electrical voltage is applied across the film (positive voltage to any spot on one outer layer face and negative voltage to any spot on the opposite outer layer face), a flow of electricity occurs from face to face through the interior, high-resistivity layer material. Through face-to-face current flow, the middle layer produces resistive heat evenly throughout. Due to the way a resistive material behaves when conducting from face to face, the watt density (e.g. watts per square meter) for a given applied voltage is constant, regardless of the area covered by the film. This effect can take place at a very low, harmless voltage.

The consequences of the present invention's behavior make it extremely useful for a wide variety of applications. An advantage of the present invention is that it can be easily and inexpensively mass-produced and may be made extremely thin and lightweight. So the film may be cut with ordinary scissors, or any other cutting method applied to thin materials, into any shape desired without the risk of severing an interior element. Any cut shape will still maintain even warmth at every point as long as the shape is contiguous. Even if an application requires non-contiguous parts, the individual parts can simply be electrically interconnected in parallel with wires and the whole will perform the same as one contiguous shape. The film can be produced in pre-engineered bulk rolls or sheets which can be used for a given application simply by cutting the film to shape and applying voltage at any point on the opposite surfaces of the heated film and produce the rated heating characteristics.

Another advantage of the present invention is that is exhibits constant watt-density over its entire surface regardless of size and at a constant, low, harmless voltage. So very large areas can be heated without the need for higher, hazardous voltages. This also allows the present invention to be powered with batteries, solar panels, fuel cells, or any other low-voltage power source.

Another advantage of the present invention is that it can be sewn like fabric without degrading its performance. Possible uses for this could be its use in or as heated clothing, curtains, tents, furniture, carpet, or any other heated application involving fabric or thin foils or films.

Yet another advantage of the present invention is that power can be applied at any point on its opposite surfaces. So there is no need to permanently locate terminal ends for a given piece of heating film, since they can be located anywhere.

The present invention is also very rugged. It can sustain considerable damage and still function perfectly.

### BRIEF DESCRIPTION OF DRAWINGS

For a better understanding of the present invention, reference may be made to the accompanying drawings in which:

FIG. 1 is a cross-sectional view detailing the construction of the heating film.

FIG. 2 is a perspective view of a wire conductor illustrating ordinary linear conduction.

FIG. 3 is a perspective view of a flat sheet conductor illustrating face-to-face conduction.

### DETAILED DESCRIPTION OF THE INVENTION

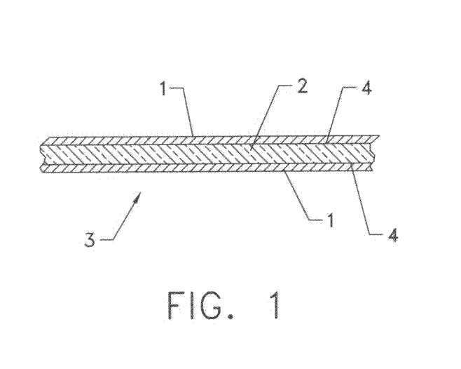

Referring to FIG. 1 it can be seen that the heating material 3 is constructed from a plurality layers comprising a very thin, electrically-conductive, high-resistivity interior layer 2 that has had very thin, electrically-conductive, low-resistivity outer layers 1 applied or affixed to its faces. These outer layers are so applied or affixed as to ensure that there is continuous electrical contact at the interface surfaces 4. This can be accomplished by using an electrically-conductive adhesive at the interfaces 4, by applying the outer layers 1 as a coating, electroplating, electro-deposition, or other methods to bond the layers together at the interface surfaces, or by other bonding methods. The high-resistivity interior layer may also be applied as a coating, electroplating, electro-deposition, or any other method. As long as the interior, high-resistivity layer 2 and the outer, low-resistivity layers 1 are assembled with good electrical contact over the interface surfaces 4, the heating film 3 will exhibit face-to-face conduction and warm evenly throughout, when an electrical voltage is applied to the exposed faces of the outer layers 1.

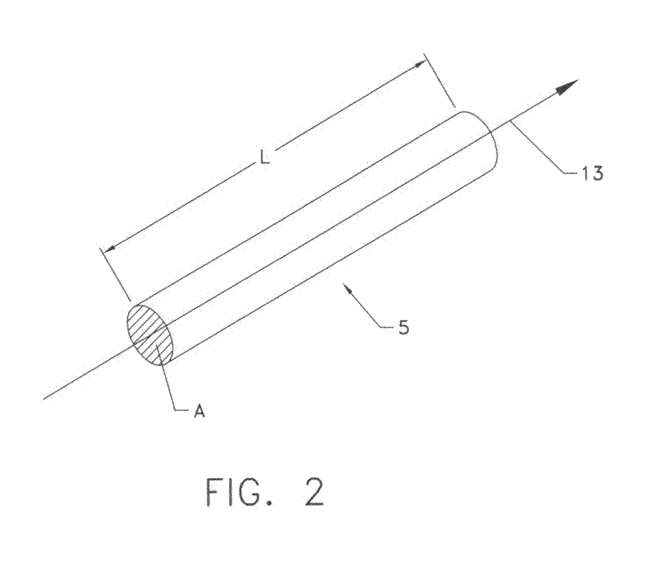

To fully understand the operational characteristics of the present invention, it is necessary to explain the phenomenon of face-to-face conduction. In FIG. 2 is shown a segment of ordinary electrical wire 5 to illustrate linear conduction as is in common use for carrying electrical current through wires. The direction of electrical current passing through the conductor is indicated by the arrow 13.

From classical physics we know that, at a given ambient temperature, the resistance to electrical current flow in a solid object is

$$R = \frac{ρ L}{A} \qquad ( 1 )$$

where R=total resistance of the wire segment,
ρ=volume resistivity of the wire material,
L=length of the wire segment,
A=cross-sectional area of the wire.
   The area A and length L are shown in FIG. 2. Resistivity ρ is an intrinsic property of a given material and is an indication of its natural resistance to the flow of electricity. The resistivity of a good conductor, like silver or copper, would be low, while the resistivity of a poor conductor, like wood or glass, would be very high.
   So, in an ordinary electrical wire 5 where the length is much greater than the cross-sectional diameter, we can see from equation (1) that increasing the length L of the conductor increases the total resistance R of the wire. Conversely, increasing the diameter of the wire increases its cross-sectional area A, which decreases its total resistance R. This is why larger conductors are used to carry higher currents, since their lower resistance allows a greater flow of electricity without excessive heating of the wire due to its resistance.

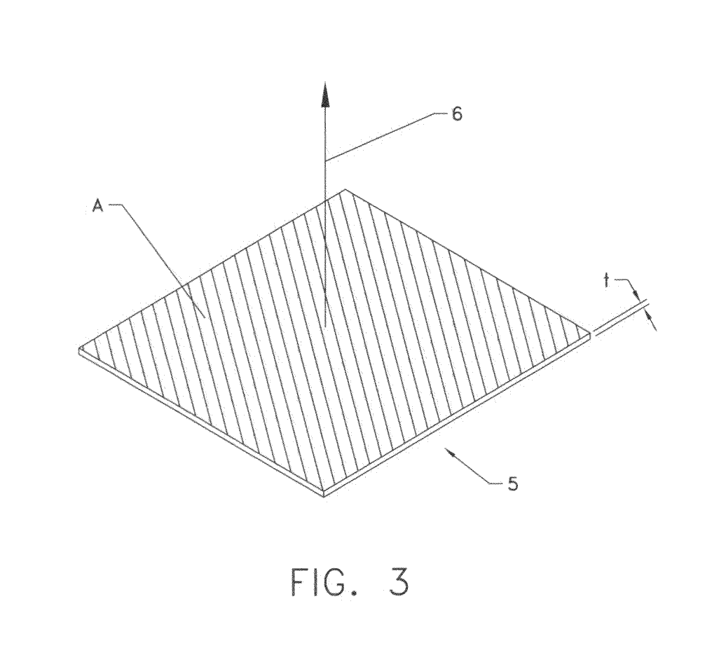

But electrical conduction has different implications when passed face to face through a flat sheet conductor. Such a flat conductor 5 is shown in FIG. 3 with the direction of electrical current indicated by the arrow 6. In the case of face-to-face conduction through a flat sheet, the cross-sectional area A would be the surface area of the sheet (hatched area) and the conducting length would be the sheet's thickness. The area A and thickness t are shown in FIG. 3. Replacing the term L in equation (1) with t, for thickness, the equation for total resistance becomes

$$R = \frac{ρ t}{A} \qquad ( 2 )$$

From classical physics we know that the rate of heat dissipation P of a resistive material depends on its resistance R and the voltage applied to it V, by the relation

$$P = \frac{{V}^{2}}{R} \qquad ( 3 )$$

where P=heat dissipation rate (e.g. “watts”).
V=applied voltage.
   Substituting equation (2) for the resistance R of face-to-face conduction in equation (3) we have

$$P = \frac{{V}^{2} A}{ρ t} \qquad ( 4 )$$

which is the total heat dissipation that emanates from the flat conductor 5.

The distributed heat dissipation per unit area, or “watt density” (e.g. “watts per square meter”) would be equal to the heat dissipation rate P divided by the total area that heat radiates from. Since heat can radiate from both sides of the sheet, the total area would be 2A (neglecting the minuscule amount of heat dissipation that would emanate from the thin edges of the sheet). If both sides of equation (4) are divided by the total surface area 2A we are left with the relation

$$Watt density = \frac{P}{2 A} = \frac{{V}^{2}}{2 ρ t} \qquad ( 5 )$$

And since the resistivity ρ of a material is constant, we can say that for a sheet material of given thickness t and resistivity ρ, the amount of heat that flows in each unit area of film depends only on the voltage V and is independent of the area A. This means that if a voltage is applied to the two faces, the film will radiate the same heat over its entire surface, regardless of size. It makes no difference if the sheet has a surface area of one square meter or 1000 square meters: it will still heat with the same watt density at a given voltage. Only the current draw will increase. This is because as the sheet conductor becomes larger, its total resistance becomes smaller, as opposed to the behavior of a wire conductor.

It is necessary that the outer layers 1 of the heating film 3 be made from a material possessing very low electrical resistivity in order that the interior, high-resistivity layer 2 has a uniform electrical voltage potential applied across its interface surfaces 4. In this way, electrical voltage can be applied at any point on the surface of the outer layers 1 and this electrical voltage will remain the same at any other point over the rest of the surface, with very little or no degradation of electrical potential as the distance from the voltage application point increases, due to internal resistances in the outer layers.

Since the conducting area A is very large in comparison to the conducting thickness t the operating voltage can be quite low and the resistivity of the interior, high-resistivity layer can be very high. Its resistivity falls within the common range for standard, inexpensive, graphite-filled semiconductive plastic film sheets that are routinely used for static dissipation applications. A preferred construction of the heated film would be to apply ordinary copper or aluminum foil, with a conductive adhesive backing, directly to both faces of graphite-filled semiconductive plastic film.

While several specific uses for the present invention have been mentioned above, there is no limit to its possible uses. It is intended as a bulk product for use in any application requiring heat. It can also be used where it is desired to replace an existing heating material with one that is thinner, lighter, easier to use, less expensive, more rugged, and/or safer.

1. A heating film comprising:
at least one very thin interior layer of an electrically-conductive material possessing a high electrical resistivity;
a plurality of very thin outer layers of electrically-conductive material possessing a low electrical resistivity.

2. The apparatus according to claim 1, wherein the low-resistivity outer layers are affixed or applied to the faces of the high-resistivity interior layer(s), producing face-to-face contact at the common interface surfaces.

3. The apparatus according to claim 2, wherein the interface surfaces between the high-resistivity interior layer(s) and the low-resistivity outer layers make electrical contact over a portion or all of the contacting area of each interface.

4. The apparatus according to claim 2, wherein the interface surfaces between the high-resistivity interior layer(s) and the low-resistivity outer layers are attached to one another by an intermediate layer of an electrically-conductive adhesive material.

5. The apparatus according to claim 3 or claim 4, wherein the assembled heating material is very thin so that it is flexible and can be handled, stored, cut, folded, or otherwise treated like ordinary fabric, film or paper.
